(19) United States
(12) Patent Application Publication
(10) Pub. No.: US 2016/0280907 A1
(43) Pub. Date: Sep. 29, 2016

(54) CURABLE COMPOSITIONS WHICH FORM INTERPENETRATING POLYMER NETWORKS

(71) Applicant: BLUE CUBE IP LLC, Midland, MI (US)

(72) Inventors: Chao ZHANG, Shanghai (CN); Yanli FENG, Shanghai (CN); Hongyu CHEN, Shanghai (CN); Michael J. MULLINS, Houston, TX (US); Yi ZHANG, Shanghai (CN); Jiawen XIONG, Shanghai (CN); Lijing FANG, Shenzhen (CN); Guihong LIAO, Shanghai (CN)

(21) Appl. No.: 15/032,814

(22) PCT Filed: Oct. 28, 2014
(86) PCT No.: PCT/US2014/062615

§ 371 Date: Apr. 28, 2016

(30) Foreign Application Priority Data
Oct. 31, 2013 (CN) PCTCN2013086378

(51) Int. Cl. C08L 63/00; C09D 163/00; C09D 5/18; C08J 5/24

(52) U.S. Cl. CPC C08L 63/00; C08J 5/24; C09D 163/00; C09D 5/18; C08L 2201/02; C08L 2205/04; C08L 2203/206; C08L 2201/08; C08L 2203/16; C08L 2312/00; C08J 2363/02; C08J 2435/00

(57) ABSTRACT

A curable composition comprising a) an epoxy component; b) a hardener component selected from the group consisting of a maleic anhydride-containing compound, a maleic anhydride-containing vinyl compound, and combinations thereof; and c) a vinyl component wherein upon curing under curing conditions, the curable composition forms at least one interpenetrating polymer network is disclosed.

### FIELD OF DISCLOSURE

Embodiments of the present disclosure relate to curable compositions and in particular to curable compositions that include polymers that form interpenetrating polymer networks upon curing.

### BACKGROUND

Curable compositions are compositions that include thermosettable monomers that are able to be crosslinked. Crosslinking, also referred to as curing, converts curable compositions into crosslinked polymers (i.e., a cured product) useful in various fields such as, for example, composites, electrical laminates and coatings. Some properties of curable compositions and crosslinked polymers that can be considered for particular applications include mechanical properties, thermal properties, electrical properties, optical properties, processing properties, among other physical properties.

Curable compositions can be cured to form an interpenetrating polymer network (IPN), which is depicted in FIG. 1. An IPN is a combination of two or more polymers that form networks wherein at least one polymer is polymerized and/or crosslinked as a network in the presence of the other polymers. Systems that can be dually cured are useful for forming an IPN.

Glass transition temperature, dielectric constant and dissipation factor are examples of properties that are considered as highly relevant for curable compositions used in electrical laminates. For example, having a sufficiently high glass transition temperature for an electrical laminate can be very important in allowing the electrical laminate to be effectively used in assembly processes and service environments to resist working temperature. Similarly, decreasing the dielectric constant (Dk) and dissipation factor (Df) of the electrical laminate can assist in minimizing signal loss in high speed transmissions.

It is well known that vinyl systems tend to have low Dk and Df values, but due to the lack of polar groups, they also tend to have low peel strength with copper and low bonding strength to glass fiber. Meanwhile, resins comprising an epoxy composition and a hardener generally have good adhesion to either copper or glass fiber, but tend to have higher Dk and Df values after curing, due to polar groups present after curing. Maleated polybutadiene (LPBMA) is a multifunctional vinyl that can also be used as an epoxy hardener. However, epoxy resins cured with LPBMA have lower glass transition temperatures (Tg). Therefore, an affordable electrical laminate with a desired balance of thermal properties, adhesion properties and electrical properties would be beneficial.

### BRIEF DESCRIPTION OF THE FIGURE

FIG. 1 depicts an interpenetrating polymer network structure.

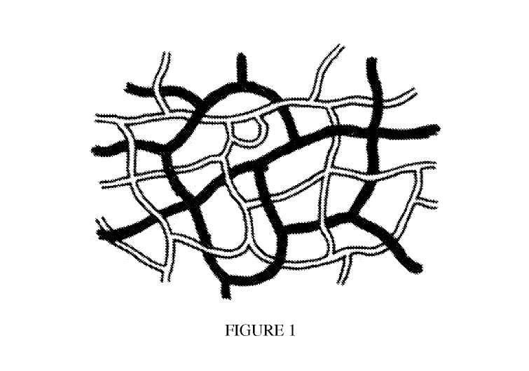

### SUMMARY

One broad aspect of the present invention discloses a curable composition comprising, consisting of, or consisting essentially of a) an epoxy component; b) a hardener component selected from the group consisting of a maleic anhydride-containing compound, a maleic anhydride-containing vinyl compound, and combinations thereof; and c) a vinyl component and wherein, upon curing under curing conditions, the curable composition forms at least one interpenetrating polymer network.

### DETAILED DESCRIPTION

### Epoxy Component

The present invention curable composition includes at least one epoxy resin. The epoxy resin may be saturated or unsaturated, aliphatic, cycloaliphatic, aromatic or heterocyclic and may be substituted. The epoxy resin may also be monomeric or polymeric.

The epoxy resins may vary and can include conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

Particularly suitable epoxy resins known to the skilled worker are based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known to the skilled worker include reaction products of epichlorohydrin with o-cresol and, respectively, phenol novolacs. Further epoxy resins include epoxides of divinylbenzene or divinylnaphthalene. It is also possible to use a mixture of two or more epoxy resins.

The epoxy resins useful in the present invention may be selected from commercially available products; for example, D.E.N.® (‘DEN’) 425, DEN 438, DEN 439, D.E.R.® (‘DER’) 332, DER 331, DER 383, DER 530, DER 538, DER 542, DER 560, DER 592, and DER 593, epoxy resins available from The Dow Chemical Company, and mixtures of any two or more thereof.

For one or more embodiments, the curable composition comprises a multifunctional epoxy resin. In various embodiments, the multifunctional epoxy resin is present in the epoxy component in the range of from 0 weight percent to 100 weight percent, is present in the range of from 0 weight percent to 60 weight percent in various other embodiments, and is present in the range of from 0 weight percent to 50 weight percent in yet various other embodiments, based on the total weight of the epoxy component.

In various embodiments, the epoxy component can comprise a flame retardant epoxy resin. Examples of epoxy resins with flame retardant compounds include, but are not limited to aliphatic epoxy resins, cycloaliphatic epoxy resins, bisphenol A epoxy resins, bisphenol F epoxy resins, phenol novolac epoxy resins, cresol-novolac epoxy resins, biphenyl epoxy resins, polyfunctional epoxy resins, naphthalene epoxy resins, divinylbenzene dioxide, 2-glycidylphenylglycidyl ether, dicyclopentadiene-type epoxy resins, phosphorous containing epoxy resins, multi aromatic resin type epoxy resins, and mixtures of any two or more thereof.

### Hardener

For one or more embodiments, the curable composition comprises a polymeric anhydride hardener. Generally, the hardener is selected from the group consisting of a maleic anhydride-containing compound, a maleic anhydride-containing vinyl compound, and combinations thereof. In various embodiments, the polymeric anhydride is a maleic anhydride. In various embodiments, the hardener component can be formed by the copolymerization of a vinyl-containing compound and a maleic anhydride.

Examples of the hardener can include, but are not limited to polybutadiene co-maleic anhydride, styrene-maleic anhydride, maleinized polybutadiene styrene copolymer, and combinations thereof. Specific examples include, but are not limited to (SMA) or maleinized polybutadiene styrene copolymer (SBMA), maleated polybutadiene (LPBMA) and mixtures of any two or more thereof.

The epoxy component and hardener component are together generally present in the curable composition in an amount in the range of from 0.1 weight percent to 99.9 weight percent, based on the total weight of the curable composition. In another embodiment, the epoxy component and hardener component are present together in an amount in the range of from 0.1 weight percent to 60 weight percent.

### Vinyl Component

In one or more embodiments, the curable composition contains a vinyl component. In various embodiments, the vinyl component has a number average molecular weight in the range of from 80 to 10000 and is in the range of from 1000 to 2000 in various other embodiments. In various embodiments, the vinyl component comprises vinyl groups that are reactive with epoxide groups. Examples of vinyl components that can be used include, but are not limited to vinyl capped poly(phenylene ether) (vinyl PPO), 1,3,5-triallyl isocyanurate (TAIC), divinylbenzene (DVB), dicyclopentadiene (DCPD), vinyl capped tetrabromobisphenol A (VTBBA), vinyl capped bisphenol A, vinyl capped phenol novolac, vinyl capped napthol novolac (VNPN), bismaleimide, maleated rosin, and mixtures of any two or more thereof.

In an embodiment, the vinyl component is present in an amount in the range of from 0.1 weight percent to 99.9 weight percent, based on the total weight of the curable composition. The vinyl component is present in the curable composition in the range of from 0.1 weight percent to 50 weight percent in another embodiment, and is present in the range of from 0.1 weight percent to 40 weight percent in yet another embodiment.

### Optional Components

In one or more embodiments, the curable composition can also include an initiator for free radical curing. Examples of such free radical initiators include, but are not limited to dialkyldiazenes (AIBN), 2,5-dimethyl-2,5-di(tert-butylperoxy)hexane, diaroyl peroxides such as benzoyl peroxide (BPO), dicumyl peroxide (DCP), disulfides, and mixtures thereof.

The free radical initiator is generally present in the curable composition in an amount in the range of from 0.01 weight percent to 10 weight percent, based on the total weight of the curable composition. In another embodiment, the free radical initiator is present in an amount in the range of from 0.1 weight percent to 8 weight percent, and is present in an amount in the range of from 2 weight percent to 5 weight percent in yet another embodiment.

Optionally, catalysts can be added to the curable composition. Examples of catalysts that can be used include, but are not limited to 2-methyl imidazole (2MI), 2-phenyl imidazole (2PI), 2-ethyl-4-methyl imidazole (2E4MI), 1-benzyl-2-phenylimidazole (1B2PZ), boric acid, triphenylphosphine (TPP), tetraphenylphosphonium-tetraphenylborate (TPP-k) and mixtures thereof.

The catalyst is generally present in the curable composition in an amount in the range of from 0.01 weight percent to 20 weight percent, based on the total weight of the curable composition. In another embodiment, the catalyst is present in an amount in the range of from 0.05 weight percent to 10 weight percent, and is present in an amount in the range of from 0.02 weight percent to 3 weight percent in yet another embodiment.

In one or more embodiments, the curable composition can also include additional flame retardants. Examples of flame retardants include halogen containing compounds, such as, for example, brominated polyphenols such as tetrabromobisphenol A (TBBA) and tetrabromobisphenol F and materials derived therefrom: TBBA-diglycidyl ether, reaction products of bisphenol A or TBBA with TBBA-diglycidyl ether, and reaction products of bisphenol A diglycidyl ether with TBBA. In various embodiments, a composition that does not contain halogen can be used, such as, for example phosphorus-containing compounds. Examples of phosphorus-containing compounds that can be used include but are not limited to HCA, dimethylphosphite, diphenylphosphite, ethylphosphonic acid, diethylphosphinic acid, methyl ethylphosphinic acid, phenyl phosphonic acid, vinyl phosphonic acid, phenolic (HCA-HQ); tris(4-hydroxyphenyl)phosphine oxide, bis(2-hydroxyphenyl)phenylphosphine oxide, bis(2-hydroxyphenyl)phenylphosphinate, tris(2-hydroxy-5-methylphenyl)phosphine oxide, M-acid-AH, bis(4-aminophenyl)phenylphosphate, various materials derived from DOP (9,10-dihydro-9-oxa-10-phosphaphenanthrene 10-oxide) such as DOP-hydroquinone (10-(2′,5′-dihydroxyphenyl)-9,10-dihydro-9-oxa-10-phosphaphenanthrene 10-oxide), condensation products of DOP with glycidylether derivatives of novolacs, and inorganic flame retardants such as aluminum trihydrate, aluminum hydroxide (Boehmite) and aluminum phosphinite.

Mixtures of one or more of the above described flame retardants can also be used.

In one or more embodiments, the curable composition can also include fillers. Examples of fillers include but are not limited to silica, aluminum trihydrate (ATH), magnesium hydroxide, carbon black, and combinations thereof.

The filler is generally present in the curable composition in an amount in the range of from 0.01 weight percent to 50 weight percent, based on the total weight of the curable composition. In another embodiment, the filler is present in an amount in the range of from 1 weight percent to 50 weight percent, and is present in an amount in the range of from 1 weight percent to 30 weight percent in yet another embodiment.

In one or more embodiments, the curable composition can contain a solvent. Examples of solvents that can be used include, but are not limited to methyl ethyl ketone (MEK), dimethylformamide (DMF), ethyl alcohol (EtOH), propylene glycol methyl ether (PM), propylene glycol methyl ether acetate (DOWANOL™ PMA) and mixtures thereof.

The solvent can generally be present in the curable composition in an amount in the range of from 0 weight percent to 70 weight percent, based on the total weight of the curable composition. In another embodiment, the solvent is present in an amount in the range of from 1 weight percent to 50 weight percent, and is present in an amount in the range of from 30 weight percent to 50 weight percent in yet another embodiment.

### Process for Producing the Composition

The composition can be produced by any suitable process known to those skilled in the art. In an embodiment, solutions of epoxy resin, hardener and multifunctional vinyl resins are mixed together. Any other desired component, such as the optional components described above, are then added to the mixture.

In various embodiments, the composition is cured via a dual curing system to form an interpenetrating polymer network. The curing process can influence the performance of the curable composition and the laminate made from the curable composition. The curing method and temperature can influence the glass transition temperature and dissipation factor. In various embodiments, the curable composition is cured in one step. In various embodiments, the curing temperature is in the range of from 80° C. to 300° C., and is in the range of from 150° C. to 280° C. in various other embodiments. In various embodiments, the curing time is in the range of from 0.5 hours to 24 hours. Upon curing, at least one interpenetrating polymer network system is formed. In an embodiment, an interpenetrating polymer network is formed between the epoxy component and the hardener component. In another embodiment, an interpenetrating polymer network system is formed between vinyl groups in the vinyl component.

In yet another embodiment, a first interpenetrating polymer network system is formed between the epoxy component and the hardener component and a second interpenetrating polymer network system is formed between vinyl groups in the vinyl component upon curing. In various embodiments, the final product performance can be balanced by controlling the weight ratio between two IPN networks' (the vinyl component network and the epoxy+hardener network).

Embodiments of the present disclosure provide prepregs that includes a reinforcement component and the curable composition, as discussed herein. The prepreg can be obtained by a process that includes impregnating a matrix component into the reinforcement component. The matrix component surrounds and/or supports the reinforcement component. The disclosed curable compositions can be used for the matrix component. The matrix component and the reinforcement component of the prepreg provide a synergism. This synergism provides that the prepregs and/or products obtained by curing the prepregs have mechanical and/or physical properties that are unattainable with only the individual components. The prepregs can be used to make electrical laminates for printed circuit boards.

The reinforcement component can be a fiber. Examples of fibers include, but are not limited to, glass, aramid, carbon, polyester, polyethylene, quartz, metal, ceramic, biomass, and combinations thereof. The fibers can be coated. An example of a fiber coating includes, but is not limited to, boron.

Examples of glass fibers include, but are not limited to, A-glass fibers, E-glass fibers, C-glass fibers, R-glass fibers, S-glass fibers, T-glass fibers, and combinations thereof. Aramids are organic polymers, examples of which include, but are not limited to, Kevlar®, Twaron®, and combinations thereof. Examples of carbon fibers include, but are not limited to, those fibers formed from polyacrylonitrile, pitch, rayon, cellulose, and combinations thereof. Examples of metal fibers include, but are not limited to, stainless steel, chromium, nickel, platinum, titanium, copper, aluminum, beryllium, tungsten, and combinations thereof. Examples of ceramic fibers include, but are not limited to, those fibers formed from aluminum oxide, silicon dioxide, zirconium dioxide, silicon nitride, silicon carbide, boron carbide, boron nitride, silicon boride, and combinations thereof. Examples of biomass fibers include, but are not limited to, those fibers formed from wood, non-wood, and combinations thereof.

The reinforcement component can be a fabric. The fabric can be formed from the fiber, as discussed herein. Examples of fabrics include, but are not limited to, stitched fabrics, woven fabrics, and combinations thereof. The fabric can be unidirectional, multiaxial, and combinations thereof. The reinforcement component can be a combination of the fiber and the fabric.

The prepreg is obtainable by impregnating the matrix component into the reinforcement component. Impregnating the matrix component into the reinforcement component may be accomplished by a variety of processes. The prepreg can be formed by contacting the reinforcement component and the matrix component via rolling, dipping, spraying, or other such procedures. After the prepreg reinforcement component has been contacted with the prepreg matrix component, the solvent can be removed via volatilization. While and/or after the solvent is volatilized the prepreg matrix component can be cured, e.g. partially cured. This volatilization of the solvent and/or the partial curing can be referred to as B-staging. The B-staged product can be referred to as the prepreg.

For some applications, B-staging can occur via an exposure to a temperature of 60° C. to 250° C.; for example B-staging can occur via an exposure to a temperature from 65° C. to 240° C., or 70° C. to 230° C. For some applications, B-staging can occur for a period of time of 1 minute (min) to 60 min; for example B-staging can occur for a period of time from, 2 min to 50 min, or 5 min to 40 min. However, for some applications the B-staging can occur at another temperature and/or another period of time.

One or more of the prepregs may be cured (e.g. more fully cured) to obtain a cured product. The prepregs can be layered and/or formed into a shape before being cured further. For some applications (e.g. when an electrical laminate is being produced) layers of the prepreg can be alternated with layers of a conductive material. An example of the conductive material includes, but is not limited to, copper foil. The prepreg layers can then be exposed to conditions so that the matrix component becomes more fully cured.

One example of a process for obtaining the more fully cured product is pressing. One or more prepregs may be placed into a press where it subjected to a curing force for a predetermined curing time interval to obtain the more fully cured product. The press has a curing temperature in the curing temperature ranges stated above. For one or more embodiments, the press has a curing temperature that is ramped from a lower curing temperature to a higher curing temperature over a ramp time interval.

During the pressing, the one or more prepregs can be subjected to a curing force via the press. The curing force may have a value that is 10 kilopascals (kPa) to 350 kPa; for example the curing force may have a value that is 20 kPa to 300 kPa, or 30 kPa to 275 kPa. The predetermined curing time interval may have a value that is 5 s to 500 s; for example the predetermined curing time interval may have a value that is 25 s to 540 s, or 45 s to 520 s. For other processes for obtaining the cured product other curing temperatures, curing force values, and/or predetermined curing time intervals are possible. Additionally, the process may be repeated to further cure the prepreg and obtain the cured product.

The prepregs can be used to make composites, electrical laminates, and coatings.

### EXAMPLES

### Ingredients

DER™ 560 resin (diglycidyl ether of tetra-bromobisphenol A) from Dow Chemical Company
DEN™ 438EK85 resin (85% epoxy novolac in MEK) from Dow Chemical Company
TBBA (tetrabromobisphenol A) from Albemarle Corporation
Ricobond® 1756 (liquid polybutadiene co-maleic anhydride) from Cray Valley
SMA® EF 40 (styrene maleic anhydride copolymer, styrene: maleic anhydride (mole ratio)=4:1) from Cray Valley
MX9000 (vinyl capped polyphenylene ether oligomer (Mn is about 1600)) from SABIC
TAIC (1,3,5-triallyl isocyanurate) from Tokyo Chemical Industry Co. LTD
VTBBA (vinyl capped TBBA) synthesized from TBBA and vinyl benzyl chloride
VNPN (vinyl capped napthol novolac) synthesized from the napthol novolac and vinyl benzyl chloride
2-MI (2-methylimidazole) from Aldrich
2-PI (2-phenylimidazole) from Aldrich
2E-4MI (2-ethyl-4-methyl imidazole) from Aldrich
DCP(dicumyl peroxide) from Sinopharm Chemcial Reagent Co.Ltd

### Examples

### Part A

In Part A, one network formed via a free radical curing reaction with vinyl capped PPO and another network formed via a curing reaction between an epoxy and an epoxy hardener. 30 grams of MX9000 powder was dissolved in 30 grams of MEK to yield a MX9000-MEK solution (50%). 30.5 grams DER™ 560 solid resin was dissolved in 30.5 grams of MEK to get the DER™ 560 solution (50%). 29.5 grams of SMA® EF 40 solid resin was dissolved in 29.5 grams of MEK to yield a SMA® EF 40 solution (50%). The above three solutions were mixed together and an appropriate amount of 10% 2-methylimidazole solution as a catalyst was added and a uniform solution was obtained. Comparative examples A and B and Example 1 were prepared according to the formulations listed in Table 1. The resin formulation was brushed on woven glass fabrics and partially cured to prepare prepregs. The prepregs were twisted and a partially cured resin powder was obtained. The resin powder was molded at 195° C. for 1 hour in a hot press machine for testing the dielectric properties and thermal properties. In order to test the copper adhesion strength, the laminates were prepared with using 8 pieces of the above prepregs with the 1 oz copper clad and molded at 195° C. for 1 hour.

### Part B

In Part B, covalent bonds formed between two networks. A free radical curing reaction occurred between vinyl groups in LPBMA (liquid polybutadiene co-maleic anhydride) and vinyl groups in PPO. 5.2 grams of a DEN™ 438-EK85 solution, 11.0 grams DER™ 560 solid epoxy resin and 5.7 grams MEK as a solvent were mixed together to yield a uniform solution. 17.4 grams of Ricon® 1756 with high viscosity was dissolved in 17.4 grams of xylene to yield a Ricon® 1756-xylene solution (50%). 24 grams of MX9000 powder was dissolved in 24 grams of MEK to yield a MX9000-MEK solution (50%). The above three solutions were then mixed together. Appropriate amounts of TBBA powder, DCP as a radical curing initiator and 2-phenylimidazole (or 2-ethyl-4-methylimidazole) solution as a catalyst were then added to the solution. Comparative examples C, D and E and Examples 2 and 3 were prepared according to the formulations listed in Table 2. The resin formulation was poured onto a flat plate which was coated with a releasing agent. After the solvent was removed in a vacuum oven, samples were cured at 200° C. for 2 hours and the properties of the casted samples were tested. The samples were then post cured at 250° C. for another 2 hours and the properties of the post cured cast samples were tested. For the copper peel strength testing, laminates were prepared with 8 sheets of the prepregs and 1 oz copper foil using the above formulations and was molded at 200° C. for 2 hours and 250° C. for 2 hours.

### Part C

### Synthesis of VTBBA:

A reactor equipped with a stirrer, a thermometer, a reflux tube and a tube for the introduction of gases under nitrogen flow was charged with 32.64 grams of TBBA, 21.37 grams of vinyl benzyl chloride (from Sinopharm Chemical Reagent Co.,Ltd), 17.39 grams of K₂CO₃, 0.5 grams of KI, 0.8 grams of 18-crown-6 ether and 300 ml acetone and the components were stirred at a reaction temperature of 60° C. The reaction was terminated after 20 hours of stirring and the residual solid in the solution was removed. The VTBBA solution was added drop-wise into methanol. The precipitated resin was filtered and dried in the vacuum oven at 50° C. for 3 hours. 40.5 grams of a white solid was obtained.

A free radical curing reaction occurred between vinyl groups in LPBMA (liquid polybutadiene co-maleic anhydride) and vinyl groups in VTBBA. 5.2 grams of DEN™ 438-EK85 solution, 11.0 grams of DER™ 560 solid epoxy resin and 5.7 grams of MEK as a solvent were mixed together to yield a uniform solution. 25.8 grams of Ricon® 1756 with high viscosity was dissolved in 25.84 grams of xylene to get the Ricon® 1756-xylene solution (50%). 14 grams of the VTBBA white powder was dissolved in 14 grams of MEK to yield a VTBBA-MEK solution (50%). The above three solutions were mixed together. DCP as a radical curing initiator and 2-phenylimidazole (or 2-ethyl-4-methylimidazole) solution as a catalyst were both added to the solution. The VTBBA in the formulation was both the flame retardant and crosslinker. Example 4 was prepared according to the formulations listed in Table 3. The resin formulation was poured onto a flat plate which was coated with the releasing agent. After the solvent was removed in a vacuum oven, samples were cured at 200° C. for 2 hours and the properties of the casted samples were tested. Afterwards, the samples were post cured at 250° C. for another 2 hours and the properties of the post cured cast samples were tested.

### Part D

### Synthesis of VNPN in Two Steps:

### First Step: NPN Synthesis

In a 1000 ml three-necked reactor equipped with a refluxing condenser, a nitrogen inlet and temperature sensor, 72 grams of 1-naphthol (0.5 mole) was added to 500 ml of toluene. The mixture was heated to 50° C. to dissolve the 1-naphthol in the solvent. 13 grams of paraformaldehyde (0.5*0.87 mol) and 1.26 grams of oxalic acid (0.5*0.02 mol) were added. The reaction was heated to 70° C. and temperature automatically rose to 75-80° C. in 10 minutes and then dropped to 70° C. The toluene mixture was heated to reflux and stirred under nitrogen for 48 hours. The reaction mixture was then allowed to cool to 50° C. and the products precipitated from the solution. The upper toluene solution was poured out and 200 ml of ethyl acetate was added and stirred for additional 10 minutes. The ethyl acetate solution was washed by water three times and organic phase was collected and dried over anhydrous sodium sulfate for 2 hours. The solid was filtered and most of the solvent was removed under vacuum.

### Second Step: VNPN Synthesis

A reactor equipped with a stirrer, a thermometer, a reflux tube and a tube for the introduction of gases under nitrogen flow was charged with 30 grams of NPN, 36.96 grams of vinyl benzyl chloride, 30.09 grams of K₂CO₃, 1.5 grams of KI, 1.5 grams of 18-crown-6 ether and 450 ml of acetone and the components were stirred at a reaction temperature of 60° C. The reaction was terminated after 20 hours and the solid in the solution was removed. The product VNPN was obtained from the solution after purifiying by re-precipitation with methanol. 27.3 grams of a brown solid was obtained after drying in the vacuum oven at 50° C. for 3 hours.

A free radical curing reaction occurred between vinyl groups in LPBMA (liquid polybutadiene co-maleic anhydride) and vinyl groups in VNPN. 5.2 grams of DEN™ 438-EK85 solution, 11.0 grams of DER™ 560 solid epoxy resin and 5.7 grams of MEK as a solvent were mixed together to yield a uniform solution. 18.0 grams of Ricon® 1756 was dissolved in 18.0 grams of xylene to get the Ricon 1756-xylene solution (50%). 24.7 grams of VNPN powder was dissolved in 24.7 grams of MEK to yield a VNPN-MEK solution (50%). The above three solutions were mixed together. TBBA powder as a flame retardant agent, DCP as radical curing initiator and 2-phenylimidazole (or 2-ethyl-4-methylimidazole) solution as a catalyst were all added to the solution. Example 5 was prepared according to the formulations listed in Table 3. The resin formulation was poured onto a flat plate which was coated with a releasing agent. After the solvent was removed in a vacuum oven, samples were cured at 200° C. for 2 hours and the properties of the casted samples were tested. Afterwards, the samples were post cured at 250° C. for another 2 hours and the properties of the post cured cast samples were tested.

The formulations, thermal performance (Tg and Td), electrical and adhesion properties are shown in Tables 1, 2 and 3. All the data were tested on the clear cast plaques, except for the copper peel strength data obtained from the copper foil laminates.

TABLE 1
Formulation and electrical properties and thermal
performance of SMA based dual cure resin

| | Comp Ex A | Comp Ex B | Example 1 |
|---|---|---|---|
| Components | (solid wt/g) | (solid wt/g) | (solid wt/g) |
| DER ™ 560 | 15.3 | 0 | 15.3 |
| SMA ® EF 40 | 14.8 | 0 | 14.8 |
| MX9000 | 0 | 15 | 15 |
| 2-MI | 0.0122 | 0 | 0 |
| Bake condition | 195° C. −1 h | 195° C. −1 h | 195° C. −1 h |
| Tg/° C. | 166 (DMA) | 164 (DSC) | 172 (DMA) |
| Td/° C. (5% Loss) | 354 | 427 | 355 |
| Dk/1 GHz | 3.02 | 2.66 | 2.87 |
| Df/1 GHz | 0.011 | 0.002 | 0.006 |
| Peel Strength/Lb · in⁻¹ | 4.0827 | 0.2372 | 0.9184 |

TABLE 2
Formulation and electrical properties and thermal performance of LPBMA based dual cure resin

| | Comp Ex C | Comp Ex D | Comp Ex E | Example 2 | Example 3 |
|---|---|---|---|---|---|
| Components | (solid wt/g) | (solid wt/g) | (solid wt/g) | (solid wt/g) | (solid wt/g) |
| DER ™ 560 | 11.0 | 0 | 0 | 11.0 | 11.0 |
| DEN438-EK85 | 5.2 | 0 | 0 | 5.2 | 5.2 |
| Ricon ® 1756 | 17.4 | 0 | 0 | 17.4 | 17.4 |
| TBBA | 3.85 | 0 | 0 | 3.85 | 3.85 |
| MX9000 | 0 | 10 | 10 | 24 | 0 |
| TAIC | 0 | 0 | 0 | 0 | 5 |
| DCP | 1.39 | 0 | 0.4 | 1.39 | 1.39 |
| 2-PI | 0.0150 | 0 | 0 | 0.0150 | 0 |
| 2E-4MI | 0 | 0 | 0 | 0 | 0.0070 |
| Bake condition | 200° C.-2 h | 200° C.-2 h | 200° C.-2 h | 200° C.-2 h | 200° C.-2 h |
| Tg/° C. (DMA) | 115 | 165 (DSC) | 214 (DSC) | 152 | 105(Tg₁)/181(Tg₂) |
| Dk/1 GHz | 2.71 | 2.70 | NA | 2.75 | 2.78 |
| Df/1 GHz | 0.008 | 0.002 | NA | 0.007 | 0.006 |
| Bake condition | 200° C.-2 h | 200° C.-2 h | 200° C.-2 h | 200° C.-2 h | 200° C.-2 h |
| | & | & | & | & | & |
| | 250° C.-2 h | 250° C.-2 h | 250° C.-2 h | 250° C.-2 h | 250° C.-2 h |
| Tg/° C. (DMA) | 140 | 181 (DSC) | 238 (DSC) | 185 | 162 |
| Td/° C. (5% Loss) | 360 | 428 | NA | 364 | 368 |
| Dk/1 GHz | 2.69 | 2.68 | NA | 2.61 | 2.72 |
| Df/1 GHz | 0.007 | 0.002 | NA | 0.006 | 0.007 |
| Peel Strength/Lb · in⁻¹ | 7.056 | NA | NA | 6.488 | 6.1205 |

TABLE 3
Formulation and electrical properties and thermal performance
of LPBMA/new vinyl materials based dual cure resin

| | Example 4 | Example 5 |
|---|---|---|
| Components | (solid wt/g) | (solid wt/g) |
| DER ™ 560 | 11.0 | 11.0 |
| DEN438-EK85 | 5.2 | 5.2 |
| Ricon ® 1756 | 25.8 | 18.0 |
| TBBA | 0 | 3.67 |
| VTBBA | 14.0 | 0 |
| VNPN | 0 | 24.7 |
| DCP | 1.59 | 1.71 |
| 2-PI | 0.017 | 0.016 |
| Bake condition | 200 C. −2 h | 200 C. −2 h |
| Tg/° C. (DMA) | 119 | 133 |
| Dk/1 GHz | 2.88 | 2.82 |
| Df/1 GHz | 0.015 | 0.009 |
| Bake condition | 200° C. −2 h | 200° C. −2 h |
| | & | & |
| | 250° C. −2 h | 250° C. −2 h |
| Tg/° C. (DMA) | 174 | 171 |
| Td/° C. (5% Loss) | 346 | 342 |
| Dk/1 GHz | 2.80 | 2.93 |
| Df/1 GHz | 0.009 | 0.009 |

### Test Methods

### Glass Transition Temperature (Tg)

Glass transition temperature was determined by Differential Scanning calorimetry (DSC) using a Q2000 machine from TA Instruments. Typically, a thermal scan ranges from room temperature to 250° C. and heating rate of 10° C./min was used. Two heating cycles were performed, with the curve from the second cycle used for Tg determination by “middle of inflection” method.

Alternatively, the glass transition temperature was determined from tangent delta peak on a RSA III dynamic mechanical thermal analyzer (DMTA). Samples were heated from 20° C. to 250° C. at a heating rate of 3° C./min. Test frequency was 6.28 rad/s.

### Thermal Decomposition Temperature (Td)

The cured resin was evaluated on a Q50 machine from TA Instruments. The heating rate was 10° C./min. The Td is defined as temperature at 5% weight loss.

Dielectric Constant (Dₖ)/Dissipation Factor (D_{f})

An epoxy plaque was made for dielectric measurement. Prepreg powder was placed into two aluminum foils. The assembly was hot pressed at required conditions in the Table 1 to 3. An air bubble-free epoxy plaque with a thickness between 0.5 and 0.8 mm was obtained.

The dielectric constant and dissipation factor were determined by an Agilent E4991A RF Impedance/Material Analyzer equipped with Agilent 16453A test fixture under 1 GHz at 24° C. following ASTM D-150.

### Copper Peel Strength (CPS)

Copper peel strength was measured using an IMASS SP-2000 slip/peel tester equipped with a variable angle peel fixture capable of maintaining the desired 90° peel angle throughout the test. For the copper etching, 2″×4″ copper clad laminates were cut. Two strips of ¼″ graphite tape were placed lengthwise along the sample on both faces of the laminate with at least a ½″ space between them. The laminate pieces were then placed in a KeyPro bench top etcher. Once the samples were removed from the etcher and properly dried, the graphite tape was removed to reveal the copper strips. A razor blade was used to pull up ½ of each copper strip. The laminate was then loaded onto the IMASS tester. The copper strip was clamped and the copper peel test was conducted at a 90° angle with a pull rate of 2.8 in/min.

What is claimed is:

1. A curable composition comprising
a) an epoxy component;
b) a hardener component selected from the group consisting of a maleic anhydride-containing compound, a maleic anhydride-containing vinyl compound, and combinations thereof; and
c) a vinyl component
wherein upon curing under curing conditions, the curable composition forms at least one interpenetrating polymer network.

2. A curable composition in accordance with claim 1 wherein the epoxy component is selected from the group consisting of a multifunctional epoxy resin, a flame retardant epoxy resin, and combinations thereof.

3. A curable composition in accordance with claim 1 further comprising a free radical initiator selected from the group consisting of 2,2′-azobisisobuytlnitrile, 2,5-dimethyl-2,5-di(tert-butylperoxy)hexane, benzoyl peroxide, dicumyl peroxide, a disulfide, and combinations thereof; and further comprising a catalyst selected from the group consisting of 2-methyl imidazole, 2-phenyl imidazole, 2-ethyl-4-methyl imidazole, boric acid, triphenylphosphine, tetraphenylphosphonium-tetraphenylborate and mixtures thereof.

4. A curable composition in accordance with claim 2, wherein the multifunctional epoxy is present in the range of from 0 weight percent to 60 weight percent, based on the total weight of the epoxy component.

5. (canceled)

6. A curable composition in accordance with claim 1, wherein the vinyl component is selected from the group consisting of vinyl capped poly(phenylene) ether, 1,3,5-trially isocyanurate, divinylbenzene, dicyclopentadiene, vinyl capped tetrabromobisphenol A, vinyl capped bisphenol A, vinyl capped phenol novolac, vinyl capped napthol novolac, bismaleimide, maleated rosin, and combinations thereof.

7. A curable composition in accordance with claim 6 wherein the vinyl component further comprises epoxide-reactive groups and vinyl groups; wherein the epoxide-reactive groups are selected from the group consisting of anhydride groups, hydroxyl groups, and combinations thereof.

8. (canceled)

9. A curable composition in accordance with claim 1 wherein the hardener is selected from the group consisting of polybutadiene co-maleic anhydride, styrene-maleic anhydride, maleinized polybutadiene styrene copolymer, and combinations thereof.

10. A curable composition in accordance with claim 1, wherein the epoxy component and the hardener component are together present in an amount in the range of from 0.1 weight percent to 50 weight percent and the vinyl component is present in an amount in the range of from 0.1 weight percent to 50 weight percent, based on the total weight of the curable composition.

11. A curable composition in accordance with claim 1, wherein the free radical initiator is present in an amount in the range of from 0.01 weight percent to 10 weight percent, based on the total weight of the curable composition.

12. A curable composition in accordance with claim 1, wherein the curing conditions comprise a curing temperature of from 80° C. to 300° C.

13. A curable composition in accordance with claim 1, wherein upon curing under curing conditions, an interpenetrating polymer network system is formed between the epoxy component and the hardener component.

14. A curable composition in accordance with claim 1, wherein upon curing under curing conditions, an interpenetrating polymer network system is formed between vinyl groups in the vinyl component.

15. A curable composition in accordance with claim 1, wherein upon curing under curing conditions, a first interpenetrating polymer network system is formed between the epoxy component and the hardener component and a second interpenetrating polymer network system is formed between vinyl groups in the vinyl component.

16. A process comprising
a) admixing
i) an epoxy component;
ii) a hardener component selected from the group consisting of polybutadiene co-maleic anhydride, styrene-maleic anhydride, maleinized polybutadiene styrene copolymer, and combinations thereof; and
iii) a vinyl component to form a curable composition; and
b) curing the curable composition under curing conditions to form a cured product having an interpenetrating polymer network.

17. A process in accordance with claim 16 wherein the epoxy component is selected from the group consisting of a multifunctional epoxy resin, a flame retardant epoxy resin, and combinations thereof.

18. A process in accordance with claim 16, wherein the vinyl component is selected from the group consisting of vinyl capped poly(phenylene ether), 1,3,5-triallyl isocyanurate, divinylbenzene, dicyclopentadiene, vinyl capped tetrabromobisphenol A, vinyl capped napthol novolac, bismaleimide, maleated rosin, and mixtures thereof.

19. A process in accordance with claim 16 further comprising admixing in step a) a free radical initiator selected from the group consisting of 2,2′-azobisisobuytlnitrile, 2,5-dimethyl-2,5-di(tert-butylperoxy)hexane, benzoyl peroxide, dicumyl peroxide, a disulfide, and combinations thereof.

20. A process in accordance with claim 16, wherein the epoxy component and the hardener component are together present in the curable composition in an amount in the range of from 0.1 weight percent to 50 weight percent and the vinyl component is present in an amount in the range of from 0.1 weight percent to 50 weight percent, based on the total weight of the curable composition; and the free radical initiator is present in the curable composition in an amount in the range of from 0.01 weight percent to 10 weight percent, based on the total weight of the curable composition.

21. (canceled)

22. A process in accordance with claim 16, wherein the curing conditions comprise a curing temperature of from 80° C. to 300° C.

23. A process in accordance with claim 16, wherein an interpenetrating polymer network system is formed between the epoxy component and the hardener component after the curing in step b).

24. A process in accordance with claim 16, wherein an interpenetrating polymer network system is formed between vinyl groups in the vinyl component after the curing in step b).

25. A process in accordance with claim 24 wherein upon curing under curing conditions, a first interpenetrating polymer network system is formed between the epoxy component and the hardener component and a second interpenetrating polymer network system is formed between vinyl groups in the vinyl component after the curing in step b).

26. A prepreg prepared from the curable composition of claim 1.

27. An electrical laminate prepared from the curable composition of claim 1.

28. A printed circuit board prepared from the curable composition of claim 1.
